(19) United States
(12) Patent Application Publication
(10) Pub. No.: US 2026/0281698 A1
(43) Pub. Date: Sep. 17, 2026

(54) NETWORK SHARING METHOD AND APPARATUS, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 19/670,261

(22) Filed: May 7, 2026

Related U.S. Application Data
(63) Continuation of application No. PCT/CN2024/109050, filed on Jul. 31, 2024.

(30) Foreign Application Priority Data
Dec. 19, 2023 (CN) 202311762532.4

(51) Int. Cl. H04W 8/20; H04W 12/06; H04W 12/72; H04W 84/04

(52) U.S. Cl. CPC H04W 8/20; H04W 12/06; H04W 12/72; H04W 84/042

(57) ABSTRACT

A method and apparatus, a device, and a computer-readable storage medium for an improved network sharing process is provided. The method is applied to a first core network element of a first operator, and the first core network element of the first operator is connected to a second core network element of a second operator. The method obtains network interaction information of the subscription terminal after a subscription terminal of the second operator performs communication interaction with an access network of the first operator. The network interaction information of the subscription terminal is shared with the core network element of the second operator.

### CROSS REFERENCE TO RELATED APPLICATION

This application is a bypass continuation application of International Patent Application No. PCT/CN2024/109050, filed on Jul. 31, 2024, which claims priority to and is based on Chinese Patent Application No. 202311762532.4, filed on Dec. 19, 2023, the disclosures of which are incorporated herein in their entireties by reference.

### FIELD

This application relates to the field of communication technologies, and in particular, to a network sharing method and apparatus, a device, and a computer-readable storage medium.

### BACKGROUND

In mobile communication technologies, a system architecture generally includes an access network directly performing communication connection to user equipment, and a core network connected to the access network. In an application scenario in which a network needs to be upgraded or a network coverage needs to be improved, a sharing network solution may be used. There are two sharing network solutions provided in the related technology. One solution is that a plurality of operators share only the access network, and maintain independent core networks. The other solution is that the plurality of operators also share some core network elements in addition to the access network. However, in either solution, the core network of each operator needs to be connected to a shared access network, that is, one access network is connected to a plurality of core networks. This results in a large number of interfaces between the shared access network and the core networks of the plurality of operators, increasing system complexity, and further reducing system stability.

### SUMMARY

To resolve the foregoing technical problem, provided are a network sharing method and apparatus, a device, and a computer-readable storage medium.

According to an aspect of some embodiments of the present disclosure, a network sharing method, applied to a first core network element of a first operator, the core network element of the first operator being connected to a second core network element of a second operator, the method including: after a subscription terminal of the second operator performs communication interaction with an access network of the first operator, obtaining network interaction information of the subscription terminal; and sharing the network interaction information of the subscription terminal with the core network element of the second operator.

According to an aspect of some embodiments of the present disclosure, a network sharing apparatus, applied to a first core network element of a first operator, the first core network element of the first operator being connected to a second core network element of a second operator, including: at least one memory configured to store program code; and at least one processor configured to read the program code and operate as instructed by the program code, the program code including: a first obtaining code configured to cause the at least one of the at least one processor to: after a subscription terminal of the second operator performs communication interaction with an access network of the first operator, obtain network interaction information of the subscription terminal; and a sharing code configured to cause the at least one of the at least one processor to share the network interaction information of the subscription terminal with the core network element of the second operator.

According to an aspect of some embodiments of the present disclosure, a non-transitory computer-readable storage medium, storing computer code applied to a first core network element of a first operator, the first core network element of the first operator being connected to a second core network element of a second operator, the computer code which, when executed by at least one processor, causes the at least one processor to at least: after a subscription terminal of the second operator performs communication interaction with an access network of the first operator, obtaining network interaction information of the subscription terminal; and sharing the network interaction information of the subscription terminal with the core network element of the second operator.

According to an aspect of some embodiments of the present disclosure, another network sharing method, applied to a core network element of a second operator, a subscription terminal of the second operator being connected to a core network of a first operator through an access network of the first operator, and the method including: connecting to a core network element of the first operator; and receiving network interaction information of the subscription terminal transmitted by the core network element of the first operator, the network interaction information of the subscription terminal being generated by the subscription terminal by performing communication interaction with the access network of the first operator. The method further includes obtaining original subscription information used by the subscription terminal in a second operator network; mapping the original subscription information to mapped subscription information used by the subscription terminal in a first operator network; and sharing the mapped subscription information with the core network element of the first operator. The method further includes obtaining original subscription information used by the subscription terminal in a second operator network; and transmitting the original subscription information to the core network element of the first operator or another entity, to map, through the core network element of the first operator or the another entity, the original subscription information to mapped subscription information used by the subscription terminal in a first operator network. The network interaction information includes a state of the subscription terminal, and the method further includes generating network selection configuration information of the subscription terminal when the subscription terminal is in an idle state or an inactive state, the network selection configuration information comprising a priority of PLMN selection or a priority of communication frequency selection performed by the subscription terminal; and transmitting the network selection configuration information to the core network element of the first operator, to transmit the network selection configuration information to the subscription terminal through the core network element of the first operator. The method further includes generating a QoS requirement corresponding to the subscription terminal; and transmitting the QoS requirement to the core network element of the first operator, so that the core network of the first operator controls, based on the QoS requirement, a PDU session established between the subscription terminal and the core network of the first operator. The network interaction information further includes session information, and the method further includes performing, based on the session information, traffic statistics on data transmission between the subscription terminal and the core network of the first operator. The network information of the subscription terminal includes location information, and the method further includes generating location-based service data based on the location information of the subscription terminal; and transmitting the location-based service data to the subscription terminal through the core network element of the first operator. According to an aspect of some embodiments of the present disclosure, another network sharing apparatus, applied to a core network element of a second operator, a subscription terminal of the second operator being connected to a core network of a first operator through an access network of the first operator, and the apparatus including: a connection module, configured to connect to a core network element of the first operator; and a first receiving module, configured to receive network interaction information of the subscription terminal transmitted by the core network element of the first operator, the network interaction information of the subscription terminal being generated by the subscription terminal by performing communication interaction with the access network of the first operator.

According to an aspect of some embodiments of the present disclosure, the core network element of the first operator is connected to the core network element of the second operator, the subscription terminal of the second operator is connected to the core network of the first operator through the access network of the first operator, and a core network of the second operator does not need to be directly connected to the access network of the first operator, so that system complexity is reduced while network sharing is realized, thereby further improving system stability. In addition, the core network element of the first operator shares the network interaction information of the subscription terminal of the second operator with the core network element of the second operator, so that the second operator provides a service for the subscription terminal thereof based on the network interaction information.

The above general descriptions and the following detailed descriptions are merely for exemplary and explanatory purposes, and cannot limit the present disclosure. Details of one or more embodiments of the present disclosure are set forth in the accompanying drawings and descriptions below. Other features and advantages of the present disclosure will be apparent from the specification, accompanying drawings, and claims

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a deployment architecture of a network sharing mechanism according to an embodiment of the present disclosure.

FIG. 2 is a schematic diagram of a network interaction corresponding to the network sharing architecture shown in FIG. 1.

FIG. 3 is a flowchart of a network sharing method according to an exemplary embodiment of the present disclosure.

FIG. 4 is a flowchart of a network sharing method according to another exemplary embodiment of the present disclosure.

FIG. 5 is a flowchart of a network sharing method according to still another exemplary embodiment of the present disclosure.

FIG. 6 is a flowchart of a network sharing method according to still another exemplary embodiment of the present disclosure.

FIG. 7 is a flowchart of a network sharing method according to still another exemplary embodiment of the present disclosure.

FIG. 8 is a flowchart of a network sharing method according to still another exemplary embodiment of the present disclosure.

FIG. 9 is a block diagram of a network sharing apparatus according to an exemplary embodiment of the present disclosure.

FIG. 10 is a block diagram of a network sharing apparatus according to another exemplary embodiment of the present disclosure.

FIG. 11 is a schematic structural diagram of a computer system adapted to implement a network sharing device according to an embodiment of the present disclosure.

### DETAILED DESCRIPTION

Exemplary embodiments are described in detail herein, and examples of the exemplary embodiments are shown in the accompanying drawings. When the following descriptions relate to the accompanying drawings, unless otherwise indicated, same numbers in different accompanying drawings represent same or similar elements. The implementations described in the following exemplary embodiments do not represent all implementations consistent with the present disclosure. On the contrary, the implementations are merely examples of apparatuses and methods that are described in detail in the appended claims and that are consistent with some aspects of the present disclosure.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions. The flowcharts (i) do not need to include all content and operations/blocks, and (ii) do not need to be performed in the described orders, either. For example, some operations/blocks may be further divided, while some operations/blocks may be combined or partially combined. Therefore, an actual execution order may change according to an actual case.

“Plurality of” mentioned in the present disclosure refers to two or more. The “and/or” describes an association relationship for describing associated objects and represents that three relationships may exist. For example, A and/or B may represent the following three cases: only A exists, both A and B exist, or only B exists. The character “/” generally represents an “or” relationship between the associated objects.

The terms such as “first”, “second”, “third”, and “fourth” in the specification, claims, and the accompanying drawings of the present disclosure are used to distinguish different objects and are not used to describe a specific sequence. The terms “include”, “have”, and any variant thereof are intended to cover a non-exclusive inclusion. For example, a process, method, system, product, or device that includes a series of operations or units is not limited to the listed operations or units; and instead, the process, the method, the system, the product, or the device may further (i) include an operation or unit that is not listed, or (ii) include another operation or unit that is intrinsic to the process, the method, the product, or the device.

To resolve a problem in an existing network sharing solution, an embodiment of the present disclosure provides a more flexible network sharing mechanism, which not only supports sharing between different operator networks, but also does not need to establish a direct interface between (i) an access network of an operator providing shared resources and (ii) a core network of an operator participating in the sharing, thereby facilitating service provision for an increasing number of virtual operators.

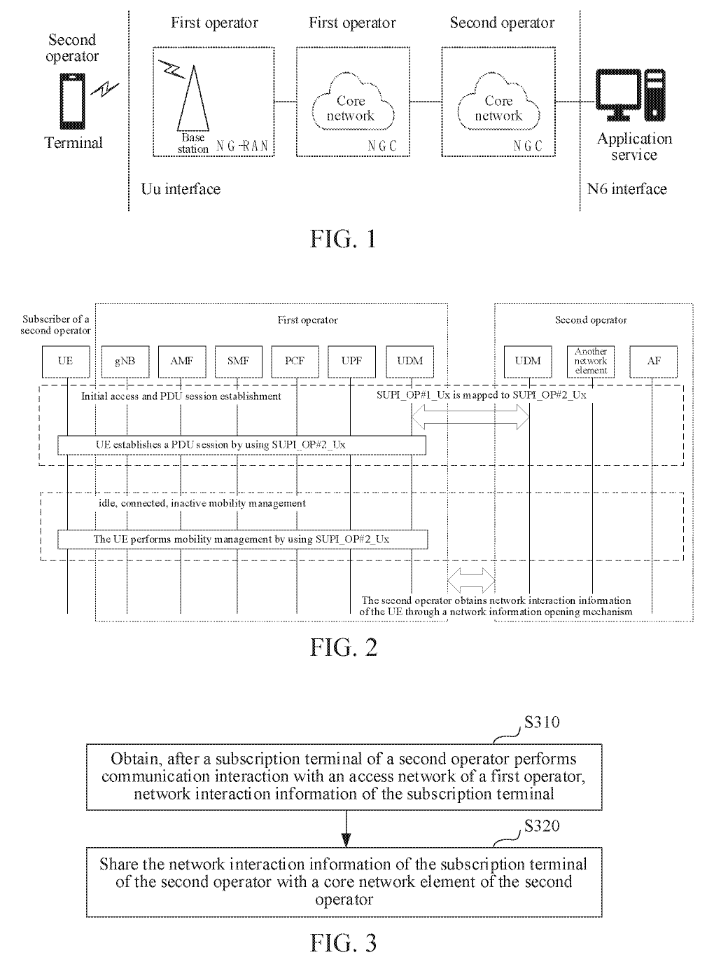

FIG. 1 is a schematic diagram of a deployment architecture of a network sharing mechanism according to an embodiment of the present disclosure. A first operator shown in FIG. 1 is an operator providing shared resources, a second operator is an operator participating in sharing, and a terminal, such as user equipment (UE), is a subscription terminal of the second operator, to be specific, the terminal uses a subscriber identity module (SIM) card of the second operator. The subscription terminal of the second operator is connected to a core network of the first operator through an access network of the first operator, and a core network of the second operator is connected to the core network of the first operator, so that after the subscription terminal of the second operator performs communication interaction with the access network of the first operator, the second operator can obtain network interaction information of the subscription terminal from the core network of the first operator in a manner of network information opening. The network interaction information of the subscription terminal of the second operator includes, but is not limited to, one or more types of information such as a location, a state, a session, and a quality of service flow (QoS flow).

Under the network sharing architecture shown in FIG. 1, the second operator only needs to establish the core network, and does not need to have a direct N2/N3 interface with the access network of the first operator. In other words, the core network of the operator participating in the sharing is not directly connected to the access network of the operator providing the shared resources. On the premise of implementing network sharing, system complexity is reduced, thereby ensuring system stability and facilitating service provision for an increasing number of virtual operators.

In addition, under the network sharing architecture shown in FIG. 1, a first operator network may be responsible for access and mobility management of the subscription terminal of the second operator. For example, an access and mobility management function (AMF) network element of the first operator implements a function of performing access and mobility management on the subscription terminal of the second operator. The first operator network may also be responsible for session management of the subscription terminal of the second operator. For example, the first operator provides a session management function (SMF) of the subscription terminal of the second operator. The first operator network may also be responsible for an authentication and certification function of the subscription terminal of the second operator. For example, the first operator provides a unified data management (UDM) function of the subscription terminal of the second operator. The second operator may provide the UDM function.

Network elements included by operators in the foregoing network sharing architecture are merely exemplary. For example, the core network of the first operator may further include other network elements. For another example, the core network of the second operator (i) may also have AMF and SMF network elements, and (ii) may also perform corresponding management, but is not directly connected to the access network of the first operator.

Further, under the network sharing architecture shown in FIG. 1, the second operator may not provide the AMF function and the SMF function of the subscription terminal of the second operator, but in some application scenarios, a service provided by the second operator needs the network interaction information of the subscription terminal of the second operator, that is, in a network sharing scenario, the operator participating in the sharing also have a service processing requirement. Therefore, the present disclosure further proposes that the network interaction information of the subscription terminal of the second operator is shared by the first operator with the second operator through a network information opening mechanism.

The network information opening mechanism may be understood as follows: the first operator network provides an interface for opening network information, so that the core network element of the first operator has an information sharing capability, and therefore, the first operator can provide the network interaction information of the subscription terminal of the second operator to the core network element of the second operator. Generally, a network information opening manner is that a core network element having the information sharing capability in the first operator shares the network information with a second operator network. The core network element having this capability may be one or more of an application function (AF) network element, a network exposure function (NEF) network element, a policy control function (PCF) network element, a user plane function (UPF) network element, or another core network element. This is not limited herein.

Similarly, the core network element of the second operator obtains the network interaction information of the subscription terminal of the second operator from the first operator network through the network information opening mechanism. The second operator may obtain the network interaction information of the subscription terminal of the second operator by deploying an AF, or obtain the network interaction information of the subscription terminal of the second operator through one or more of an NEF, a PCF, a UPF, or another core network element. This is not limited in the present disclosure, either.

Based on the network information opening mechanism, the first operator is responsible for the SMF function of the subscription terminal of the second operator. Therefore, the core network of the first operator can share state information including an idle state, an inactive state, a connected state, location information, and the like of the subscription terminal of the second operator with the core network element of the second operator.

For example, when the subscription terminal of the second operator is in an idle state, the first operator can share cell level and tracking area (TA) level information of the subscription terminal of the second operator with the core network element of the second operator.

When the subscription terminal of the second operator is in the idle state or an inactive state, the first operator can share TA information and notification area information of the subscription terminal of the second operator with the core network element of the second operator. The second operator may configure a priority of public land mobile network (PLMN) selection or a priority of communication frequency selection of the subscription terminal, and transmit this configuration to the subscription terminal through the first operator in order to guide the subscription terminal to reside in or select an accessed operator network.

When the subscription terminal of the second operator is in a connected state, in addition to the foregoing location information, session information and QoS flow information of the subscription terminal of the second operator may be shared with the second operator, the second operator performs, based on the obtained QoS flow information, scheduling control on network resources allocated by the first operator to the subscription terminal of the second operator.

Further, considering that in the network sharing scenario, it is not suitable for user subscription data of the operator participating in the sharing to be completely exposed to the operator providing the shared resources, the present disclosure further provides a user subscription information mapping mechanism. The user subscription information mapping mechanism may be understood as follows: the second operator has user subscription data configured for the subscription terminal of the second operator, which is referred to as original subscription information. The first operator does not directly use the original subscription information, and the first operator uses mapped user subscription data instead, which is referred to as mapped subscription information. In other words, the original subscription information is user subscription data used by the subscription terminal of the second operator in the second operator network, and the mapped subscription information is user subscription data used by the subscription terminal of the second operator in the first operator network.

Mapping between the original subscription information and the mapped subscription information may be completed by the UDM network element of the first operator or the UDM network element of the second operator, or may be completed by another entity. The another entity is, for example, a device such as a server or a node providing a mapping function. For example, the first operator and the second operator may negotiate to determine a specific party to complete the mapping between the original subscription information and the mapped subscription information. Alternatively, when neither the first operator nor the second operator can complete the mapping, another entity may complete the mapping between the original subscription information and the mapped subscription information. Alternatively, the first operator and the second operator may negotiate a trigger condition for the another entity to complete the mapping between the original subscription information and the mapped subscription information. This is not limited herein.

A mapping manner between the original subscription information and the mapped subscription information may also be agreed by the first operator and the second operator. The mapping manner is not limited in the present disclosure. For example, the mapping between the original subscription information and the mapped subscription information may include mapping of a user identifier. For example, a user identifier of the subscription terminal of the second operator in the second operator network is SUPI_OP#1_Ux, and a user identifier in the first operator network is SUPI_OP#2_Ux, and SUPI_OP#1_Ux and SUPI_OP#2_Ux are mapped to each other. The user identifier in the foregoing example is, for example, a subscription permanent identifier (SUPI). Therefore, the subscription terminal of the second operator obtains a sharing service in the first operator by using a mapped SUPI, which can improve privacy of user data.

Certainly, the first operator network may alternatively directly use the user identifier of the subscription terminal in the second operator network. The present disclosure does not specify that the user identifier of the subscription terminal of the second operator in the second operator network needs to be mapped to the user identifier in the first operator network.

The mapping between the original subscription information and the mapped subscription information may further include selection of a service-related entry. For ease of understanding, for example, if the original subscription information includes subscription data of 100 entries subscribed by a user with the second operator, subscription data of only 10 entries needs to be used when the first operator provides the sharing service to the user. In this case, the mapping between the original subscription information and the mapped subscription information provides the subscription data of only the 10 entries to the second operator.

By performing the mapping between the original subscription information and the mapped subscription information, the mapped subscription information includes user subscription data that the first operator needs to provide the sharing service for a subscriber of the second operator, rather than all user subscription data configured by the second operator for the subscriber of the second operator. Therefore, such a mapping relationship can also isolate the user subscription data. The operator providing the shared resources only obtains user subscription data related to providing the sharing service, and does not need all the user subscription data, thereby implementing minimal sharing of the user subscription information.

Further, given the network sharing scenario, a charging rule generated for the network sharing between the first operator and the second operator is also independent. In the network sharing architecture provided in the present disclosure, because the first operator shares the network interaction information of the subscription terminal of the second operator with the first operator in a manner of network information opening, the first operator independently charges a subscriber of the first operator based on the network interaction information obtained through the sharing. How the first operator and the second operator finally perform settlement may also be determined through negotiation between the operators. A settlement rule is not limited in the present disclosure.

The network sharing architecture shown in FIG. 1 is only an example of a network architecture part related to implementation of the network sharing scenario. In an actual application scenario, a subscription terminal of the first operator is also connected to the core network of the first operator through the access network of the first operator, and some subscription terminals of the second operator may be connected to the core network of the second operator through an access network of the second operator. Because this does not relate to a network sharing process, a network interaction process is not described in the present disclosure.

FIG. 2 is a schematic diagram of a network interaction corresponding to the network sharing architecture shown in FIG. 1. Corresponding to the network sharing architecture shown in FIG. 1, a first operator is an operator providing shared resources, and a second operator is an operator participating in sharing.

A subscription terminal (UE) used by a subscriber of the second operator accesses a core network of the first operator through a base station (gNB) of the first operator. Therefore, the first operator is responsible for an AMF function and an SMF function of the UE. Referring to FIG. 2, a base station (gNB), an AMF network element, an SMF network element, a PCF network element, a UPF network element, and a UDN network element of the first operator establish a PDU session of the UE and perform mobility management of the UE.

The second operator only needs to construct a core network. For example, as shown in FIG. 2, the core network of the second operator includes a UDM network element, an authentication, authorization, and accounting (AAA) network element, an AF network element, or another network element, and core network elements of the second operator are connected to core network elements of the first operator. It can be learned that the core network of the second operator does not need to be directly connected to the base station (gNB) of the first operator, thereby reducing a quantity of interfaces between a shared access network and a core network of an operator in a network sharing scenario. On the premise of implementing the network sharing scenario, a system service level is reduced, thereby ensuring system stability.

Certainly, the second operator may also construct an access network. For example, a subscription terminal that does not use a sharing network provided by the first operator is still connected to the core network of the second operator through the access network of the second operator. However, because the access network of the second operator may not participate in network sharing, the access network of the second operator is not shown in FIG. 2, either. Similarly, the core network of the second operator may also have network elements such as AMF and SMF elements configured to provide a network service to the subscription terminal of the second operator when the subscription terminal of the second operator does not need to use the sharing network. However, because these core network elements do not participate in the network sharing, the access network of the second operator is not shown in FIG. 2, either.

In addition, because a service provided by the second operator has a requirement for obtaining UE information, for example, independently charging the UE using the sharing network, recommending location-based service data to the UE, updating an end-to-end QoS requirement based on a network state of the first operator, or configuring network selection information of the UE, the first operator further provides a network information opening mechanism to share network interaction information of the UE with the second operator.

To avoid a case that user subscription data of the operator participating in the sharing is completely exposed to the operator providing the shared resources, based on a user subscription information mapping mechanism, original subscription information used by the UE in a second operator network needs to be mapped to mapped subscription information used by the UE in a first operator network. As shown in FIG. 2, a user identifier SUPI_OP#1_Ux of the UE in the second operator network is mapped to a user identifier UPI_OP#2_Ux of the UE in the first operator network. Therefore, the UE establishes the PDU session and performs access and mobility management in the first operator network by using the UPI_OP#2_Ux.

In this way, in the network sharing scenario in which the shared access network and the core network of the operator are not directly connected, the present disclosure implements provision of end-to-end mobile service support, including access control and mobility management of terminals in different states, and avoids sharing user subscription information between an operator network providing the shared resources and an operator network participating in the sharing, which is applicable to a network sharing solution in which the shared access network and the core network of the operator are not directly connected in a core network form such as a 5^{th} generation mobile communication technology (5G) or a 6^{th} generation mobile communication technology (6G).

Based on the network sharing architecture shown in FIG. 1, embodiments of the present disclosure further correspondingly provide a network sharing method, a network sharing apparatus, a network sharing device, a computer-readable storage medium, and a computer program product. The embodiments are described in detail below.

FIG. 3 is a flowchart of a network sharing method according to an exemplary embodiment of the present disclosure. The method is applied to a core network element of a first operator. As shown in FIG. 1, the core network element of the first operator is connected to a core network element of a second operator, and a subscription terminal of the second operator is connected to a core network of the first operator through an access network of the first operator. Therefore, the core network of the first operator provides a sharing service to the subscription terminal of the second operator.

As shown in FIG. 3, the exemplary network sharing method includes S310 and S320, which are described in detail as follows:

S310: Obtain, through the access network of the first operator after the subscription terminal of the second operator performs communication interaction with the access network of the first operator, network interaction information of the subscription terminal.

In a network sharing scenario, the subscription terminal of the second operator is connected to the core network of the first operator through the access network of the first operator. Therefore, the subscription terminal of the second operator may perform communication interaction with the access network of the first operator. The communication interaction includes, but is not limited to, access and mobility management, session management, and the like performed by the first operator on the subscription terminal of the second operator.

Correspondingly, the network interaction information of the subscription terminal of the second operator that can be obtained by the core network element of the first operator includes, but is not limited to, one or more types of information such as a location, a state, a session, and a QoS flow of the subscription terminal.

The core network of the first operator may obtain the network interaction information of the subscription terminal of the second operator through the access network of the first operator, or may obtain the foregoing network interaction information through another network element, for example, an AF, a PCF, or another network element. This is not limited in the present disclosure.

S320: Share the network interaction information of the subscription terminal of the second operator with the core network element of the second operator.

The core network element of the first operator shares the network interaction information of the subscription terminal of the second operator with the core network element of the second operator, so that the core network of the second operator can still provide a service to a corresponding subscription terminal based on the obtained network interaction information.

For example, the second operator may transmit, based on a location of a subscription terminal accessing a first operator network, to the subscription terminal of the second operator, service data, such as restaurant recommendation information and surrounding map information, matching a terminal location of the subscription terminal through the core network and the access network of the first operator. This is not limited herein.

For another example, the second operator may configure a priority of PLMN selection or a priority of communication frequency selection for a subscription terminal in an idle state or an inactive state, and transmit information about this configuration to a subscription terminal of the second operator through the core network and the access network of the first operator to guide the subscription terminal to reside in or select an accessed operator network. The operator network may be the first operator network or a second operator network, or may be another operator network. Specific configuration content of the second operator is not limited herein.

For another example, the second operator may independently charge the subscription terminal based on session information of the subscription terminal of the second operator in a connected state.

For another example, the second operator may generate a corresponding QoS requirement based on QoS flow information of the subscription terminal of the second operator in the connected state, and transmit the QoS requirement to the core network element of the first operator, so that the first operator schedules, based on the received QoS requirement, network resources allocated to the subscription terminal of the second operator in order to ensure that end-to-end QoS satisfies a service requirement.

It may be learned from the foregoing that the network sharing method provided in this embodiment is implemented based on the network sharing architecture shown in FIG. 1. The core network of the second operator participating in the sharing does not need to be directly connected to the access network of the first operator providing the shared resources, thereby reducing a quantity of interfaces between a shared access network and a core network of an operator. On the premise of implementing network sharing, system complexity is reduced, thereby improving system stability, and facilitating service provision for an increasing number of virtual operators. In addition, the first operator providing the shared resources shares network interaction information of the subscriber of the second operator participating in the sharing with the second operator in a manner of network information opening, and this can also satisfy a service processing requirement of the operator participating in the sharing in the network sharing scenario.

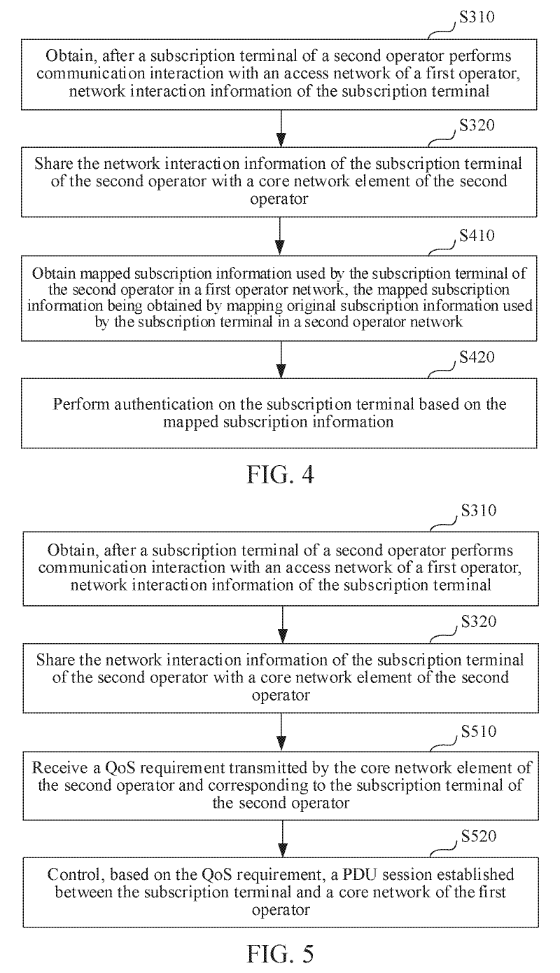

In another exemplary embodiment, as shown in FIG. 4, the network sharing method further includes S410 and S420, which are described in detail as follows:

S410: Obtain mapped subscription information used by a subscription terminal of a second operator in a first operator network, the mapped subscription information being obtained by mapping original subscription information used by the subscription terminal in a second operator network.

To avoid a case that user subscription data of the subscription terminal of the second operator is completely exposed to the first operator, the user subscription data of the subscription terminal needs to be mapped. To be specific, user subscription data used by the subscription terminal of the second operator in the second operator network is the original subscription information, user subscription data used by the subscription terminal in the first operator network is the mapped subscription information, and the mapped subscription information is obtained by mapping the original subscription information. Content related to mapping between the original subscription information and the mapped subscription information has been recorded in the foregoing embodiment, and therefore is not described herein again.

In addition, as recorded in the foregoing embodiment, a network element completing the mapping between the original subscription information and the mapped subscription information may be a UDM network element of the first operator or a UDM network element of the second operator, or another entity having user subscription data mapping. Therefore, there may also be plurality of manners in which a core network element of the first operator obtains the mapped subscription information of the subscription terminal of the second operator. For example, in some implementations, the core network element of the first operator receives the original subscription information regarding the subscription terminal transmitted by a core network element of the second operator, and obtains the mapped subscription information by mapping the original subscription information. For another example, the core network element of the first operator directly receives the mapped subscription information transmitted by the core network element of the second operator or the another entity.

S420: Perform authentication on the subscription terminal based on the mapped subscription information.

The core network element of the first operator, for example, the UDM network element, performs authentication on the subscription terminal of the second operator based on the mapped subscription information of the subscription terminal. The authentication may be understood as including user identification or identity verification.

Therefore, in the network sharing method provided in this embodiment, in a manner of the user subscription data mapping, the user subscription data of an operator participating in sharing can be prevented from being completely exposed to an operator providing shared resources, thereby improving user data privacy in a network sharing scenario.

In another exemplary embodiment, as shown in FIG. 5, the network sharing method further includes S510 and S520, which are described in detail as follows:

S510: Receive a QoS requirement transmitted by a core network element of a second operator and corresponding to a subscription terminal of the second operator.

The QoS requirement disclosed in this embodiment may include an initial QoS requirement or an updated QoS requirement. To satisfy user requirements for different quality of service across different applications, a core network of a first operator providing shared resources also needs to have a QoS function. A protocol data unit (PDU) session between the core network of the first operator and an accessed subscription terminal of the second operator is established based on the initial QoS requirement, so that resource allocation provided to the subscription terminal by the core network of the first operator satisfies a user requirement for quality of service.

A core network element of the first operator transmits QoS flow information of the subscription terminal of the second operator to the core network element of the second operator, so that the second operator can determine, based on the obtained QoS flow information, whether the QoS requirement of the subscription terminal needs to be changed. For example, when a first operator network is congested, a requirement for quality of service of the subscription terminal needs to be lowered. When the QoS requirement needs to be changed, the core network element of the second operator transmits a new QoS requirement to the core network element of the first operator.

S520: Control, based on the QoS requirement, the PDU session established between the subscription terminal and the core network of the first operator.

The core network element of the first operator controls, based on the received QoS requirement, the PDU session established between the corresponding subscription terminal and the core network of the first operator, including the foregoing PDU session established based on the initial QoS requirement, and further including a modified PDU session established between the subscription terminal and the core network of the first operator based on the new PDU session, so that resource allocation provided by the core network of the first operator to the subscription terminal keeps matching the user requirement for quality of service.

Therefore, in the network sharing method provided in this embodiment, even if a core network of the second operator participating in sharing is not directly connected to an access network of the first operator providing the shared resources, based on a network information sharing mechanism provided by the first operator, the second operator can still implement quality of service control over the subscription terminal accessing the first operator, satisfying a service requirement, and implementing predictability of sharing network performance, so that a network bandwidth can be effectively allocated in a sharing network, thereby implementing more proper utilization of network resources in a network sharing scenario.

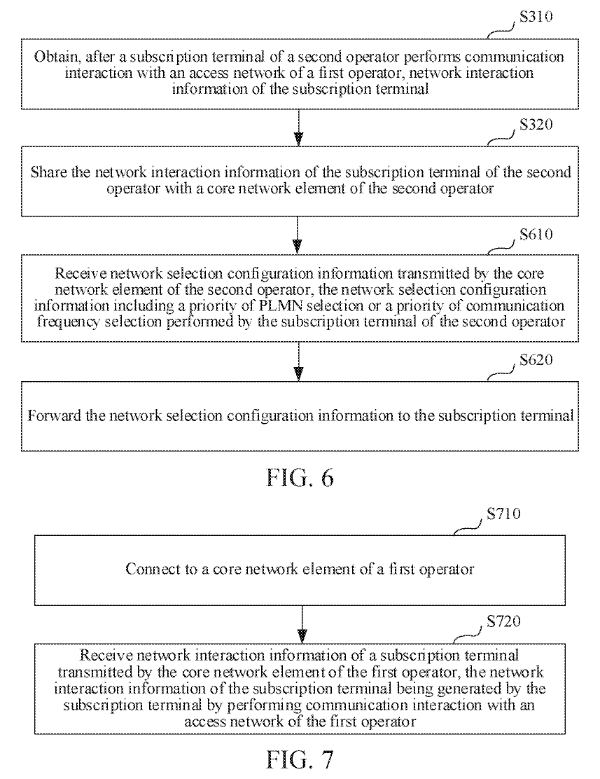

In another exemplary embodiment, as shown in FIG. 6, the network sharing method further includes S610 and S620, which are described in detail as follows:

S610: Receive network selection configuration information transmitted by a core network element of a second operator, the network selection configuration information including a priority of PLMN selection or a priority of communication frequency selection performed by a subscription terminal of the second operator.

Based on a network information opening mechanism provided by a first operator, a core network element of the first operator shares location and state information of the subscription terminal of the second operator with the second operator. When the subscription terminal is in an inactive state, the second operator can configure the priority of PLMN selection or the priority of communication frequency selection of the subscription terminal, to generate the network selection configuration information. The network selection configuration information is configured to guide the subscription terminal to reside in or select a network of the first operator, the second operator, or another operator.

S620: Forward the network selection configuration information to the subscription terminal.

After receiving the network selection configuration information transmitted by the core network element of the second operator, the core network element of the first operator forwards the received network selection configuration information to the corresponding subscription terminal of the second operator through an access network, so that the subscription terminal resides in or selects the network of the first operator, the second operator, or another operator based on the network selection configuration information.

Therefore, in the network sharing method provided in this embodiment, even if a core network of the second operator participating in sharing is not directly connected to the access network of the first operator providing shared resources, based on a network information sharing mechanism provided by the first operator, the second operator can still guide the subscription terminal accessing the first operator to select an operator network, thereby satisfying a service control requirement of an operator participating in the sharing for a subscriber in a network sharing scenario.

Similarly, based on the network information sharing mechanism provided by the first operator, the second operator participating in the sharing may further transmit service data to the subscription terminal through the first operator providing the shared resources, for example, the foregoing recommendation data based on a terminal location. This is not limited herein.

It can be obtained from the foregoing that in a scenario in which a shared access network is not directly connected to a core network of an operator, end-to-end service support can still be provided by using the network sharing solution provided in this embodiment of the present disclosure.

FIG. 7 is a flowchart of a network sharing method according to another exemplary embodiment of the present disclosure. The method is applied to a core network element of a second operator. Also as shown in FIG. 1, a subscription terminal of the second operator is connected to a core network of a first operator through an access network of the first operator, and the core network of the first operator provides a sharing service to the subscription terminal of the second operator.

As shown in FIG. 7, the exemplary network sharing method includes the following operations:

S710: Connect to a core network element of the first operator.

S720: Receive network interaction information of the subscription terminal transmitted by the core network element of the first operator, the network interaction information of the subscription terminal being generated by the subscription terminal by performing communication interaction with the access network of the first operator.

Under a network sharing architecture provided in the present disclosure, the core network of the first operator participating in sharing is not directly connected to an access network of the second operator providing shared resources, but the second operator needs to obtain the network interaction information of the subscription terminal of the second operator in a second operator network, to perform related service processing. Therefore, the core network element of the second operator is connected to the core network element of the first operator based on a network information opening mechanism provided by the first operator, to obtain, through the core network element of the first operator after the subscription terminal of the second operator performs communication interaction with the access network of the first operator, the network interaction information.

As recorded in the foregoing embodiment, the network interaction information of the subscription terminal obtained by the core network element of the second operator may be one or more types of information such as a location, a state, a session, and a QoS flow of the subscription terminal. Based on the obtained network interaction information, the second operator may provide, based on a service requirement of the second operator, a service to the subscription terminal through the first operator.

For example, the core network element of the second operator generates network selection configuration information when the subscription terminal of the second operator is in an idle state or an inactive state. The network selection configuration information includes a priority of PLMN selection or a priority of communication frequency selection performed by the subscription terminal, and transmits the network selection configuration information to the core network element of the first operator, to transmit the network selection configuration information to the subscription terminal through the core network element of the first operator. The subscription terminal resides in or selects an operator network to connect to the operator network based on the received network selection configuration information.

For example, the core network element of the second operator generates a QoS requirement corresponding to the subscription terminal, and transmits the QoS requirement to the core network element of the first operator, so that the core network of the first operator controls a PDU session of the subscription terminal based on the QoS requirement.

For example, the core network element of the second operator generates location-based service data based on location information of the subscription terminal of the second operator, and transmits the location-based service data to the corresponding subscription terminal through the core network element of the first operator.

For example, the core network element of the second operator performs, based on session information of the subscription terminal of the second operator, traffic statistics on data transmission between the subscription terminal of the second operator and the core network of the first operator, thereby independently charging the subscription terminal of the second operator.

The foregoing related service processing process performed by the core network element of the second operator based on the obtained network interaction information of the subscription terminal of the second operator in a first operator network has been recorded in the foregoing embodiment. Therefore, detailed descriptions are not provided in this embodiment.

Therefore, in the network sharing method provided in this embodiment, based on the network sharing architecture shown in FIG. 1, the core network of the second operator participating in the sharing does not need to be directly connected to the access network of the first operator providing the shared resources, thereby reducing a quantity of interfaces between a shared access network and a core network of an operator. On the premise of implementing network sharing, system complexity is reduced, system stability is improved, and service provision for an increasing number of virtual operators is facilitated. In addition, the first operator providing the shared resources shares the network interaction information of the subscriber of the second operator participating in the sharing with the second operator in a manner of network information opening, which can satisfy a service processing requirement of the operator participating in the sharing in the network sharing scenario, for example, implementing quality of service control over the subscription terminal accessing the first operator, guiding the subscription terminal accessing the first operator to select the operator network, transmitting service data to the subscription terminal, and independently charging the subscription terminal using a sharing network.

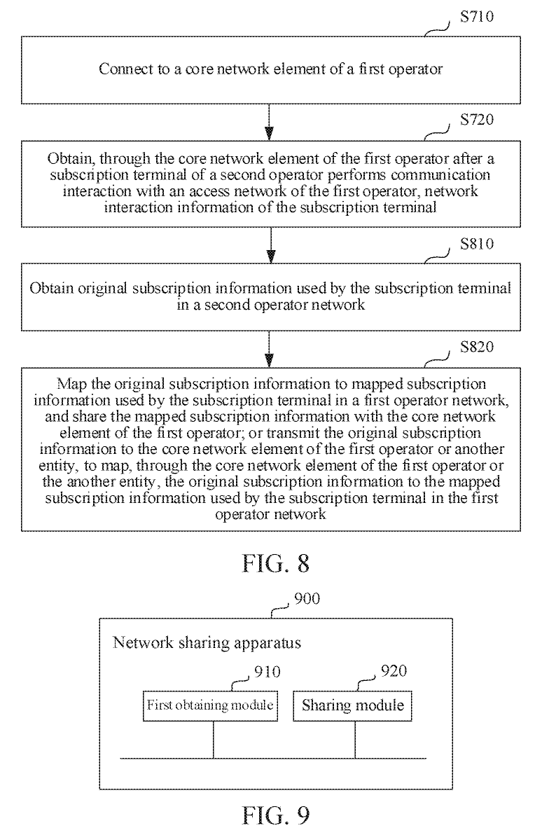

In another exemplary embodiment, as shown in FIG. 8, the network sharing method further includes the following operations:

S810: Obtain original subscription information used by a subscription terminal in a second operator network.

S820: Map the original subscription information to mapped subscription information used by the subscription terminal in a first operator network, and share the mapped subscription information with a core network element of a first operator; or transmit the original subscription information to the core network element of the first operator or another entity, to map, through the core network element of the first operator or the another entity, the original subscription information to the mapped subscription information used by the subscription terminal in the first operator network.

Under the network sharing architecture provided in the present disclosure, the subscription terminal of a second operator participating in sharing obtains a data service through the first operator network providing shared resources. Based on subscription of the subscription terminal in the second operator network, a core network element of the second operator can obtain the original subscription information of the subscription terminal of the second operator. For example, the core network element of the second operator may be a UDM network element.

As described above, to avoid a case that user subscription data of the subscription terminal of the second operator is completely exposed to the first operator, the user subscription data of the subscription terminal needs to be mapped. To be specific, the user subscription data used by the subscription terminal of the second operator in the second operator network is the original subscription information, the user subscription data used by the subscription terminal in the first operator network is the mapped subscription information, and the mapped subscription information is obtained by mapping the original subscription information. A network element completing mapping between the original subscription information and the mapped subscription information may be the UDM network element of the first operator or the UDM network element of the second operator, or another entity having user subscription data mapping. Therefore, in an embodiment in which the UDM network element of the second operator completes the mapping between the original subscription information and the mapped subscription information, the UDM network element of the second operator further shares the mapped subscription information with the core network element of the first operator. However, in an embodiment in which the UDM network element of the first operator or the another entity completes the mapping between the original subscription information and the mapped subscription information, the UDM network element of the second operator transmits the original subscription information to the UDM network element of the first operator or the another entity.

A more detailed process related to the user subscription data mapping is recorded in the foregoing embodiment. Therefore, it can be obtained that, in the network sharing method provided in this embodiment, in a manner of the user subscription data mapping, the user subscription data of an operator participating in the sharing can be prevented from being completely exposed to an operator providing the shared resources, thereby improving user data privacy in a network sharing scenario.

FIG. 9 is a block diagram of a network sharing apparatus according to an exemplary embodiment of the present disclosure. The network sharing apparatus is applied to a core network element of a first operator, and the core network element of the first operator is connected to a core network element of a second operator.

As shown in FIG. 9, an exemplary network sharing apparatus 900 includes:

a first obtaining module 910, configured to: after a subscription terminal of the second operator performs communication interaction with an access network of the first operator, obtain network interaction information of the subscription terminal; and

a sharing module 920, configured to share the network interaction information of the subscription terminal with the core network element of the second operator.

In another exemplary embodiment, the network sharing apparatus 900 further includes:

a second obtaining module, configured to obtain mapped subscription information used by a subscription terminal in a first operator network, the mapped subscription information being obtained by mapping original subscription information used by the subscription terminal in a second operator network; and

an authentication module, configured to perform authentication on the subscription terminal based on the mapped subscription information.

In another exemplary embodiment, the second obtaining module is further configured to:

receive original subscription information of a subscription terminal transmitted by a core network element of a second operator, and map the original subscription information, to obtain mapped subscription information; or

receive the mapped subscription information transmitted by the core network element of the second operator or another entity, the another entity being connected to a core network element of a first operator.

In another exemplary embodiment, the network sharing apparatus 900 further includes:

a second receiving module, configured to receive a QoS requirement transmitted by a core network element of a second operator and corresponding to a subscription terminal;

a first responding module, configured to control, based on the QoS requirement, a PDU session established between the subscription terminal and a core network based on a first operator.

In another exemplary embodiment, the network sharing apparatus 900 further includes:

a third receiving module, configured to receive network selection configuration information transmitted by a core network element of a second operator, the network selection configuration information including a priority of PLMN selection or a priority of communication frequency selection performed by a subscription terminal; and

a second responding module, configured to forward the network selection configuration information to the subscription terminal.

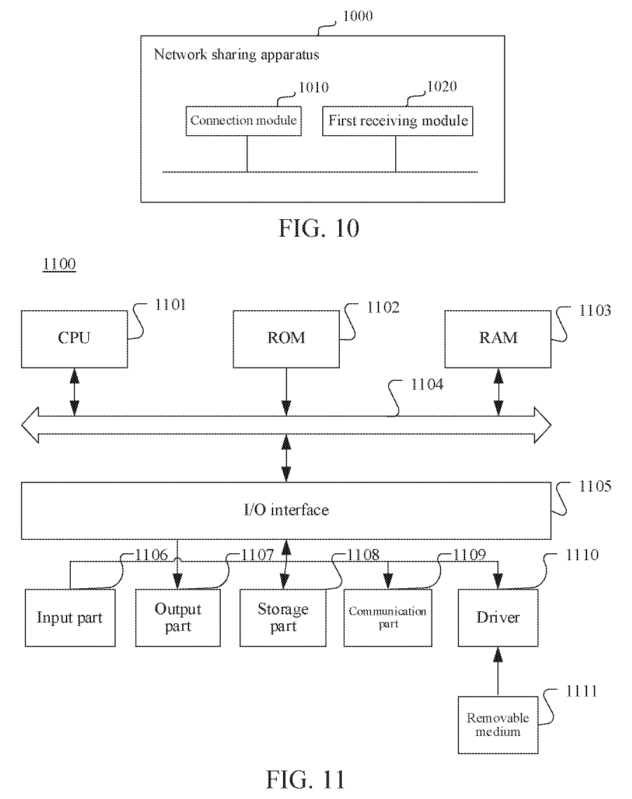

FIG. 10 is a block diagram of a network sharing apparatus according to another exemplary embodiment of the present disclosure. The network sharing apparatus is applied to a core network element of a second operator, and a subscription terminal of the second operator is connected to a core network of a first operator through an access network of the first operator.

As shown in FIG. 10, an exemplary network sharing apparatus 1000 includes:

a connection module 1010, configured to connect to a core network element of the first operator; and

a first receiving module 1020, configured to: after a subscription terminal performs communication interaction with an access network of the first operator, obtain, through the core network element of the first operator, network interaction information of the subscription terminal.

In another exemplary embodiment, the network sharing apparatus 1000 further includes:

a third obtaining module, configured to obtain original subscription information used by a subscription terminal in a second operator network; and

a first processing module, configured to map the original subscription information to mapped subscription information used by the subscription terminal in a first operator network, and share the mapped subscription information with a core network element of a first operator; or transmit the original subscription information to the core network element of the first operator or another entity, to map, through the core network element of the first operator or the another entity, the original subscription information to the mapped subscription information used by the subscription terminal in the first operator network.

In another exemplary embodiment, the network sharing apparatus 1000 further includes a second processing module, and the second processing module is configured to:

generate network selection configuration information of a subscription terminal when the subscription terminal is in an idle state or an inactive state, the network selection configuration information including a priority of PLMN selection or a priority of communication frequency selection performed by the subscription terminal, and transmit the network selection configuration information to a core network element of a first operator, to transmit the network selection configuration information to the subscription terminal through the core network element of the first operator;

generate a QoS requirement corresponding to the subscription terminal, and transmit the QoS requirement to the core network element of the first operator, so that a core network of the first operator controls, based on the QoS requirement, a PDU session established between the subscription terminal and the core network of the first operator;

perform, based on session information, traffic statistics on data transmission between the subscription terminal and the core network of the first operator; or

generate location-based service data based on location information of the subscription terminal, and

transmit the location-based service data to the subscription terminal through the core network element of the first operator.

The network sharing apparatus provided in the foregoing embodiments and the network sharing method provided in the foregoing embodiments belong to the same concept. Specific manners in which respective modules and units perform operations are described in detail in the method embodiments, and the details are not described herein again. In an actual application, the network sharing apparatus provided in the foregoing embodiments may distribute the foregoing functions to different function modules as required, that is, the internal structure of the apparatus is divided into different function modules, to complete all or some of the functions described above. This is not limited herein.

An embodiment of the present disclosure further provides a network sharing device, including: one or more processors; and a memory, configured to store one or more programs, the one or more programs, when executed by the one or more processors, causing the network sharing device to implement the network sharing method provided in the foregoing embodiments.

FIG. 11 is a schematic structural diagram of a computer system adapted to implement a network sharing device according to an embodiment of the present disclosure. A computer system 1100 of the network sharing device shown in FIG. 11 is merely an example, and does not constitute any limitation on functions and use ranges of the embodiments of the present disclosure.

As shown in FIG. 11, the computer system 1100 includes a central processing unit (CPU) 1101, which may perform various suitable actions and processing based on a program stored in a read-only memory (ROM) 1102 or a program loaded from a storage part 1108 into a random access memory (RAM) 1103, for example, perform the method described in the foregoing embodiments. The RAM 1103 further stores various programs and data required for system operations. The CPU 1101, the ROM 1102, and the RAM 1103 are connected to each other through a bus 1104. An input/output (I/O) interface 1105 is also connected to the bus 1104.

The following components are connected to the I/O interface 1105: an input part 1106 including a keyboard, a mouse, or the like, an output part 1107 including a cathode ray tube (CRT), a liquid crystal display (LCD), a speaker, or the like, the storage part 1108 including a hard disk, or the like, and a communication part 1109 including a network interface card such as a local area network (LAN) card or a modem. The communication part 1109 performs communication processing using a network such as the Internet. A driver 1110 is also connected to the I/O interface 1105 as required. A removable medium 1111 such as a magnetic disk, an optical disc, a magneto-optical disk, or a semiconductor memory is mounted on the driver 1110 as required, so that a computer program read from the removable medium 1111 is installed into the storage part 1108 as required.

Particularly, according to an embodiment of the present disclosure, the processes described in the foregoing by referring to the flowcharts may be implemented as computer software programs. For example, this embodiment of the present disclosure includes a computer program product. The computer program product includes a computer program stored in the computer-readable medium. The computer program includes a computer program used for performing the method shown in the flowchart. In such an embodiment, by using the communication part 1109, the computer program may be downloaded and installed from the network, and/or installed from the removable medium 1111. When the computer program is executed by the CPU 1101, the various functions defined in the system of the present disclosure are executed.

The computer-readable medium shown in the embodiments of the present disclosure may be a computer-readable signal medium or a computer-readable storage medium or any combination of the two. A more specific example of the computer-readable storage medium may include, but is not limited to: an electrical connection having one or more wires, a portable computer magnetic disk, a hard disk, a RAM, a ROM, an erasable programmable read-only memory (EPROM), a flash memory, an optical fiber, a compact disk read-only memory (CD-ROM), an optical storage device, a magnetic storage device, or any appropriate combination thereof. The computer program included in the computer-readable medium may be transmitted by using any suitable medium, including but not limited to: a wireless medium, a wire, or the like, or any appropriate combination thereof.

The flowcharts and block diagrams in the accompanying drawings illustrate possible system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in the block diagram or the flowchart and a combination of boxes in the block diagram or the flowchart may be implemented by using a dedicated hardware-based system configured to perform a specified function or operation, or may be implemented by using a combination of dedicated hardware and a computer instruction.

A related unit described in the embodiments of the present disclosure may be implemented in a software manner, or may be implemented in a hardware manner, and the unit described can also be set in a processor. Names of these units do not constitute a limitation on the units in a case.

Another aspect of the present disclosure further provides a computer-readable storage medium, having a computer program stored therein, the computer program, when executed by a processor, implements the network sharing method described above. The computer-readable storage medium may be included in the network sharing device described in the foregoing embodiments, or may exist alone and is not assembled into the network sharing device.

Another aspect of the present disclosure provides a computer program product or a computer program, the computer program product or the computer program including computer instructions, and the computer instructions being stored in a computer-readable storage medium. A processor of a computer device reads the computer instructions from the computer-readable storage medium, and the processor executes the computer instructions, so that the computer device executes the network sharing method provided in the foregoing embodiments.

The foregoing descriptions are merely preferable exemplary embodiments of the present disclosure, and are not intended to limit the embodiments of the present disclosure. A person of ordinary skill in the art can make corresponding modifications and variations with ease without departing from the spirit and scope of the embodiments of the present disclosure. Therefore, the protection scope of the present disclosure shall be subject to the protection scope of the claims.

In a specific implementation of the present disclosure, related data such as network interaction data is involved. When the foregoing embodiments of the present disclosure are applied to a specific product or technology, user permission or consent needs to be obtained, and collection, use, and processing of the related data needs to comply with related laws and regulations and standards of related countries and regions.

What is claimed is:

1. A network sharing method, applied to a first core network element of a first operator, the first core network element of the first operator being connected to a second core network element of a second operator, the method comprising:
after a subscription terminal of the second operator performs communication interaction with an access network of the first operator, obtaining network interaction information of the subscription terminal; and
sharing the network interaction information of the subscription terminal with the core network element of the second operator.

2. The method according to claim 1, wherein the method further comprises:
obtaining mapped subscription information used by the subscription terminal in a first operator network, the mapped subscription information being obtained by mapping original subscription information used by the subscription terminal in a second operator network; and
performing authentication on the subscription terminal based on the mapped subscription information.

3. The method according to claim 2, wherein the obtaining mapped subscription information used by the subscription terminal in a first operator network comprises:
receiving the original subscription information of the subscription terminal transmitted by the second core network element of the second operator; and
mapping the original subscription information to obtain the mapped subscription information.

4. The method according to claim 2, wherein the obtaining mapped subscription information used by the subscription terminal in a first operator network comprises:
receiving the mapped subscription information transmitted by the second core network element of the second operator or another entity, the another entity being connected to the first core network element of the first operator.

5. The method according to claim 1, wherein the method further comprises:
receiving a quality of service (QoS) requirement transmitted by the second core network element of the second operator and corresponding to the subscription terminal; and
controlling, based on the QoS requirement, a PDU session established between the subscription terminal and a core network of the first operator.

6. The method according to claim 1, wherein the method further comprises:
receiving network selection configuration information transmitted by the second core network element of the second operator, the network selection configuration information comprising a priority of public land mobile network (PLMN) selection or a priority of communication frequency selection performed by the subscription terminal; and
forwarding the network selection configuration information to the subscription terminal.

7. The method according to claim 1, wherein the network interaction information comprises session information.

8. A network sharing apparatus, applied to a first core network element of a first operator, the first core network element of the first operator being connected to a second core network element of a second operator, comprising:
at least one memory configured to store program code; and
at least one processor configured to read the program code and operate as instructed by the program code, the program code comprising:
a first obtaining code configured to cause the at least one of the at least one processor to: after a subscription terminal of the second operator performs communication interaction with an access network of the first operator, obtain network interaction information of the subscription terminal; and
a sharing code configured to cause the at least one of the at least one processor to share the network interaction information of the subscription terminal with the core network element of the second operator.

9. The network sharing apparatus according to claim 8, wherein the program code further comprising:
a second obtaining code configured to cause the at least one of the at least one processor to obtain mapped subscription information used by the subscription terminal in a first operator network, the mapped subscription information being obtained by mapping original subscription information used by the subscription terminal in a second operator network; and
a performing code configured to cause the at least one of the at least one processor to perform authentication on the subscription terminal based on the mapped subscription information.

10. The network sharing apparatus according to claim 8, wherein the second obtaining code further comprising:
a first receiving code configured to cause the at least one of the at least one processor to receive the original subscription information of the subscription terminal transmitted by the second core network element of the second operator; and
a mapping code configured to cause the at least one of the at least one processor to map the original subscription information to obtain the mapped subscription information.

11. The network sharing apparatus according to claim 8, wherein the second obtaining code further comprising:
a second receiving code configured to cause the at least one of the at least one processor to receive the mapped subscription information transmitted by the second core network element of the second operator or another entity, the another entity being connected to the first core network element of the first operator.

12. The network sharing apparatus according to claim 8, wherein the program code further comprising:
a third receiving code configured to cause the at least one of the at least one processor to receive a quality of service (QoS) requirement transmitted by the second core network element of the second operator and corresponding to the subscription terminal; and
a controlling code configured to cause the at least one of the at least one processor to control, based on the QoS requirement, a PDU session established between the subscription terminal and a core network of the first operator.

13. The network sharing apparatus according to claim 8, wherein the program code further comprising:
a fourth receiving code configured to cause the at least one of the at least one processor to receive network selection configuration information transmitted by the second core network element of the second operator, the network selection configuration information comprising a priority of public land mobile network (PLMN) selection or a priority of communication frequency selection performed by the subscription terminal; and
a forwarding code configured to cause the at least one of the at least one processor to forward the network selection configuration information to the subscription terminal.

14. The network sharing apparatus according to claim 8, wherein the network interaction information comprises session information.

15. A non-transitory computer-readable storage medium, storing computer code applied to a first core network element of a first operator, the first core network element of the first operator being connected to a second core network element of a second operator, the computer code which, when executed by at least one processor, causes the at least one processor to at least:
after a subscription terminal of the second operator performs communication interaction with an access network of the first operator, obtaining network interaction information of the subscription terminal; and
sharing the network interaction information of the subscription terminal with the core network element of the second operator.

16. The non-transitory computer-readable storage medium according to claim 15, wherein the computer code which, when executed by at least one processor, further causes the at least one processor to at least:
obtain mapped subscription information used by the subscription terminal in a first operator network, the mapped subscription information being obtained by mapping original subscription information used by the subscription terminal in a second operator network; and
perform authentication on the subscription terminal based on the mapped subscription information.

17. The non-transitory computer-readable storage medium according to claim 16, wherein the computer code which, when executed by at least one processor, further causes the at least one processor to at least:
receive the original subscription information of the subscription terminal transmitted by the second core network element of the second operator; and
map the original subscription information to obtain the mapped subscription information.

18. The non-transitory computer-readable storage medium according to claim 16, wherein the computer code which, when executed by at least one processor, further causes the at least one processor to at least:
receive the mapped subscription information transmitted by the second core network element of the second operator or another entity, the another entity being connected to the first core network element of the first operator.

19. The non-transitory computer-readable storage medium according to claim 15, wherein the computer code which, when executed by at least one processor, further causes the at least one processor to at least:
receive a quality of service (QoS) requirement transmitted by the second core network element of the second operator and corresponding to the subscription terminal; and
control, based on the QoS requirement, a PDU session established between the subscription terminal and a core network of the first operator.

20. The non-transitory computer-readable storage medium according to claim 15, wherein the computer code which, when executed by at least one processor, further causes the at least one processor to at least:
receive network selection configuration information transmitted by the second core network element of the second operator, the network selection configuration information comprising a priority of public land mobile network (PLMN) selection or a priority of communication frequency selection performed by the subscription terminal; and
forward the network selection configuration information to the subscription terminal.
